(19) United States
(12) Patent Application Publication
(10) Pub. No.: US 2015/0375532 A1
(43) Pub. Date: Dec. 31, 2015

(54) RECORDING DEVICE

(71) Applicant: SEIKO EPSON CORPORATION, Tokyo (JP)

(72) Inventors: Yoshitsugu TOKAI, Shiojiri-shi (JP); Takuya YASUE, Matsumoto-shi (JP); Yusuke SAITO, Yamagata-mura (JP); Hlroaki FUKUMOTO, Shiojiri-shi (JP)

(21) Appl. No.: 14/752,533

(22) Filed: Jun. 26, 2015

(30) Foreign Application Priority Data
Jun. 27, 2014 (JP) 2014-132275

(51) Int. Cl. B41J 11/00

(52) U.S. Cl. CPC B41J 11/0015

(57) ABSTRACT

An ink jet printer which is a recording device which ejects ink droplets onto a recording surface of a recording medium thereby recording, includes a material of slave rollers that are in contact with the recording surface in a transport path through which the recording medium is transported, the material being located on a polarity side opposite to a polarity in which mist that is generated in accordance with ejection of the ink droplets in a charge string is charged, further than a material of a member which configures the recording surface.

### BACKGROUND

1. Technical Field

The present invention relates to a recording device.

2. Related Art

An ink jet printer that is used as a recording device can record (print) images on various print media. In general, in order to record a desired image, an ink jet printer requires a transport technology of a recording medium, in addition to an ink ejection technology.

In JP-A-2008-254215, a recording device that uses a transport roller for transporting a recording medium is proposed. In order to perform skew removal, the recording device switches a nip state and a release state of a slave roller for transport of a recording medium.

However, in the recording device described in JP-A-2008-254215, there is a case in which a surface of a recording medium that is transported in a state of being interposed between a drive roller for transport and a slave roller for transport is peel-off-charged when being peeled from the slave roller for transport. As a result, there is a problem that in some case, mist that is generated when ink is ejected is attracted on a surface of a recording medium which is charged thereby contaminating the surface of the recording medium.

### SUMMARY

The invention can be realized as the following application examples or forms.

### Application Example 1

According to this application example, there is provided a recording device, which ejects ink droplets onto a recording surface of a recording medium thereby recording, including: a material of a contact member that is in contact with the recording surface in a transport path through which the recording medium is transported, the material being located on a polarity side opposite to a polarity in which mist that is generated in accordance with ejection of the ink droplets in a charge string is charged, further than a material of a member which configures the recording surface.

In this case, since the material of the contact member is the material which is located on the polarity side opposite to the polarity in which the mist that is generated in accordance with ejection of the ink droplets in the charge string is charged, further than the material of the member which configures the recording surface of the recording medium, the recording surface tends to be charged in the same polarity as a polarity in which the mist is charged, in a case in which a contact member is peeled after the contact member is in contact with the recording surface. As a result, adhesion of the mist to the recording surface is suppressed by a repulsive force that acts between the recording surface and the mist.

### Application Example 2

According to this application example, there is provided a recording device, which ejects ink droplets onto a recording surface of a recording medium thereby recording, including: a material of a contact member that is in contact with the recording surface in a transport path through which the recording medium is transported, the material being located on a negative side in a charge string, further than a material of a member which configures the recording surface.

In this case, since the material of the contact member is the material which is located on the negative side in the charge string, further than the material of the member which configures the recording surface of the recording medium, the recording surface tends to be positively charged, in a case in which the contact member is peeled after the contact member is in contact with the recording surface. As a result, adhesion of the mist to the recording surface is suppressed by a repulsive force that acts between the recording surface and the mist, in a case in which the mist that is generated when the recording device ejects ink droplets onto the recording medium is positively charged.

### Application Example 3

In the recording device according to the application example, it is preferable to further include a static elimination path through which electric charges that are charged in a contact surface on which the contact member is in contact with the recording medium move away from the contact surface.

In this case, since the recording device further includes the static elimination path through which the electric charges that are charged in the contact surface on which the contact member is in contact with the recording medium move away from the contact surface, the electric charges that are charged in the contact surface via the static elimination path can be reduced. As a result, an increase of a potential difference between the contact surface and other sites (for example, a ground potential) is suppressed, and, for example, discharging across the recording medium is suppressed.

### Application Example 4

In the recording device according to the application example, it is preferable to further include a transport portion that transports the recording medium, in which the contact member is a roller that configures the transport portion.

In this case, even if a method of making the roller which configures the transport portion that transports the recording medium in contact with the recording surface of the recording medium is used, adhesion of the mist to the surface of the recording medium is suppressed.

### Application Example 5

In the recording device according to the application example, it is preferable that the contact member contains a conductive material.

In this case, since the contact member contains a conductive material, a static elimination path that is electrically coupled to the contact member is provided, and thereby the electric charges that are charged in the contact member can move more easily via the static elimination path.

### Application Example 6

In the recording device according to the application example, it is preferable that the static elimination path electrically couples the contact member to a ground potential.

In this case, the recording device includes the static elimination path through which electric charges that are charged in the contact surface move away, and the static elimination path electrically couples the contact member to the ground potential. For this reason, the electric charges that are charged in the contact member can move to the ground potential via the static elimination path.

### Application Example 7

In the recording device according to the application example, it is preferable that a material of the contact member is a fluorine-based resin.

In this case, a material of the contact member is a fluorine-based resin. For example, in a charge string, a metal such as gold, silver, copper, or aluminum, or rubber is located on a positive side of a material such as polyester, styrene, acryl, polyurethane, polyethylene, or vinyl chloride, and in contrast to this, the fluorine-based resin is located on a negative side of the material. For this reason, there is a tendency that, in peel-off charging of the recording medium and the contact member for which a material such as polyester, styrene, acryl, polyurethane, polyethylene, or vinyl chloride is used in the surface, the contact member is negatively charged, and the recording medium is positively charged. That is, in this case, even in a case in which a material such as polyester, styrene, acryl, polyurethane, polyethylene, or vinyl chloride is used for the surface of the recording medium, adhesion of the mist to the recording surface is suppressed, in a case in which the mist that is generated when the recording device ejects ink droplets onto the recording medium is positively charged.

### BRIEF DESCRIPTION OF THE DRAWINGS

The invention will be described with reference to the accompanying drawings, wherein like numbers reference like elements.

FIG. 1 is a perspective diagram of an ink jet printer that is used as a recording device according to a first embodiment.

FIG. 2 is a side sectional diagram illustrating a portion of an internal configuration of an ink jet printer.

FIG. 3 is a schematic diagram illustrating a state in which floating mist adheres to a surface of a recording medium and thereby the surface is contaminated.

FIG. 4 is an example figure of a charge string.

FIG. 5A to FIG. 5C are schematic diagrams illustrating a state in which mist is positively charged.

FIG. 6 is a schematic diagram illustrating a configuration of a slave roller that is used as a contact member.

FIG. 7 is a schematic diagram illustrating a configuration of a slave roller according to a first modification example.

### DESCRIPTION OF EXEMPLARY EMBODIMENTS

Hereinafter, an embodiment in which the invention is specified will be described with reference to the drawings. The following description is an embodiment of the invention, and does not limit the invention. There is a case in which, in each of the following figures, the description is made in a different scale from the actual scale for clarity of explanation. In addition, in the coordinates appended in the drawings, a Z-axis direction is a vertical direction, a Z direction is an upward direction, an X-axis direction is a longitudinal direction, a −X direction is a front direction, a Y-axis direction is a horizontal direction, a +Y direction is the left direction, and an X-Y plane is a horizontal plane.

### First Embodiment

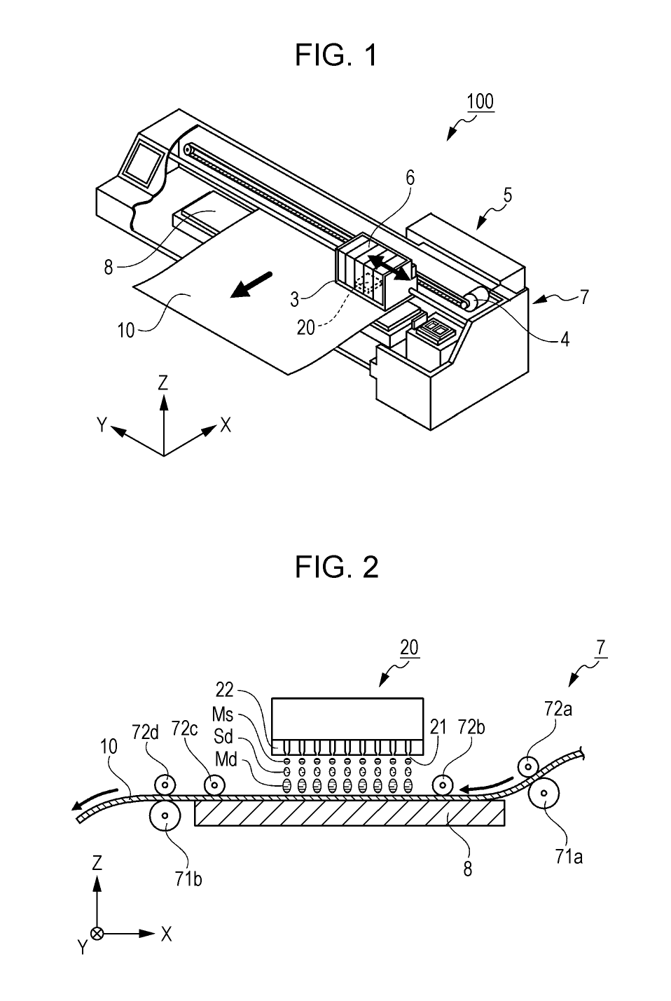

FIG. 1 is a perspective diagram of an ink jet printer 100 that is used as a recording device according to a first embodiment.

The ink jet printer 100 includes a recording head 20 of an ink jet type, a carriage 3, a carriage drive mechanism 4, a control board 5, an ink cartridge 6, a recording medium transport mechanism 7 that is used as a transport unit, a platen 8, and the like.

The ink jet printer 100 is a device that ejects droplets (hereinafter, also referred to as ink droplets) using the recording head 20 under the control of the control board 5 so as to apply the droplets to a recording medium 10, thereby recording characters, drawings, images, or the like. As a method (method of an ink jet type recording head) of ejecting the ink droplets, a piezo method is used as a preferable example. The piezo method is a method in which pressure according to a recording information signal is applied to ink stored in a pressure chamber by a piezoelectric element (piezo element), ink droplets are ejected from a liquid ejecting nozzle (hereinafter, referred to as a nozzle) communicating to the pressure chamber, thereby recording is performed.

The method of ejecting the ink droplets is not limited to this, and there may be other recording methods of ejecting ink in a droplet shape and forming a dot group on a recording medium. For example, a method in which a small pump applies pressure to ink, a nozzle is mechanically vibrated by a crystal vibrator or the like, and thereby ink droplets are forcibly ejected, and a method (thermal jet method) in which ink droplets are ejected so as to record by heating ink using a microelectrode according to the recording information signal and foaming the ink, or the like may be used.

The carriage 3 is equipped with the recording head 20 and the ink cartridge 6, and ejects ink in a substantially vertical direction (−Z direction in FIG. 1) while scanning (reciprocating motion in the Y-axis direction in FIG. 1) a recording surface of the recording medium 10 using the carriage drive mechanism 4.

The control board 5 performs a drive control of the carriage drive mechanism 4 or the recording medium transport mechanism 7, a control of ink ejection, or the like.

The ink cartridge 6 is divided into a plurality of housing portions, and houses a plurality of inks that is supplied to the recording head 20. The inks are ejected from separate nozzles that are included in the recording head 20 for each type.

The recording medium transport mechanism 7 moves the recording medium 10 in a direction (−X direction in FIG. 1) that intersects a scan direction of the carriage 3.

The platen 8 in which the recording medium 10 is mounted defines an interval between the recording head 20 and the recording medium 10.

FIG. 2 is a side sectional diagram illustrating a portion of an internal configuration of the ink jet printer 100, and illustrates a relationship between the recording medium 10, the recording head 20, the recording medium transport mechanism 7, the platen 8, or the like.

The recording medium transport mechanism 7 is configured to include drive rollers 71a and 71b, slave rollers 72a to 72d, and the like. The recording medium transport mechanism 7 supplies the recording medium 10 on the platen 8, and in addition, configures a transport path of the recording medium 10 that is discharged from the surface of the platen 8.

The recording medium 10 is interposed between the drive roller 71a that is disposed on an upstream side (+X side of FIG. 2) of the transport path and the slave roller 72a that is disposed so as to energized such that the recording medium 10 is interposed between the drive roller 71a and the slave roller 72a. The drive roller 71a rotates based on a control of the control board 5, thereby supplying the recording medium 10 on the platen 8. In addition, the drive roller 71a accurately rotates based on a control of the control board 5, and thereby the recording medium 10 on the platen 8 is accurately moved.

The recording medium 10 is interposed between the drive roller 71b that is disposed on a downstream side (−X side of FIG. 2) of the transport path and the slave roller 72d that is disposed so as to energized such that the recording medium 10 is interposed between the drive roller 71b and the slave roller 72d. The drive roller 71b rotates based on a control of the control board 5, thereby moving (discharging) the recording medium 10. In addition, the drive roller 71b rotates while applying tension to the recording medium 10 in the −X direction, and thereby the recording medium 10 on the platen 8 is moved without deflection.

The slave rollers 72b and 72c are disposed so as to be energized such that the slave rollers press the platen 8 while the recording medium 10 is interposed on an upper side of the platen 8. The recording medium 10 is moved by the slave rollers 72b and 72c on an upper surface of the platen 8 without being lifted from the platen 8.

That is, in the present embodiment, the slave rollers 72a to 72d are “contact members” that are in contact with a recording surface of the recording medium 10 in a transport path through which the recording medium 10 is transported.

The recording head 20 includes a nozzle plate 22 in which a plurality of nozzles 21 that ejects ink droplets is provided. The recording head 20 ejects (discharging) ink droplets onto the recording medium 10 that is held at a predetermined position and height by the recording medium transport mechanism 7 and the platen 8, based on a control of the control board 5, while being moved by the carriage 3 and scanning, thereby forming an image on a surface of the recording medium 10.

In recent years, in order to form a more accurate image, ink droplets (a liquid amount of ink) that are ejected from the nozzle 21 tend to decrease. In order to reliably land an extremely small amount of ink droplets on the recording medium 10, initial speed of the ink droplets is set to be relatively high. According to this, the ink droplets that are ejected from the nozzle 21 are stretched in flight, and are divided into main liquid droplets Md of head and satellite droplets Sd (subdroplets) subsequent to the main droplets. All or a portion of the satellite droplets Sd is further divided, and thereby the speed thereof is decreased by a viscous resistance of the air and the satellite droplets may become mist without reaching the recording medium. There is a case in which the satellite droplets (mist Ms) that are made to be mist float in an inside of the ink jet printer 100, and adhere to an electrically affinitive site.

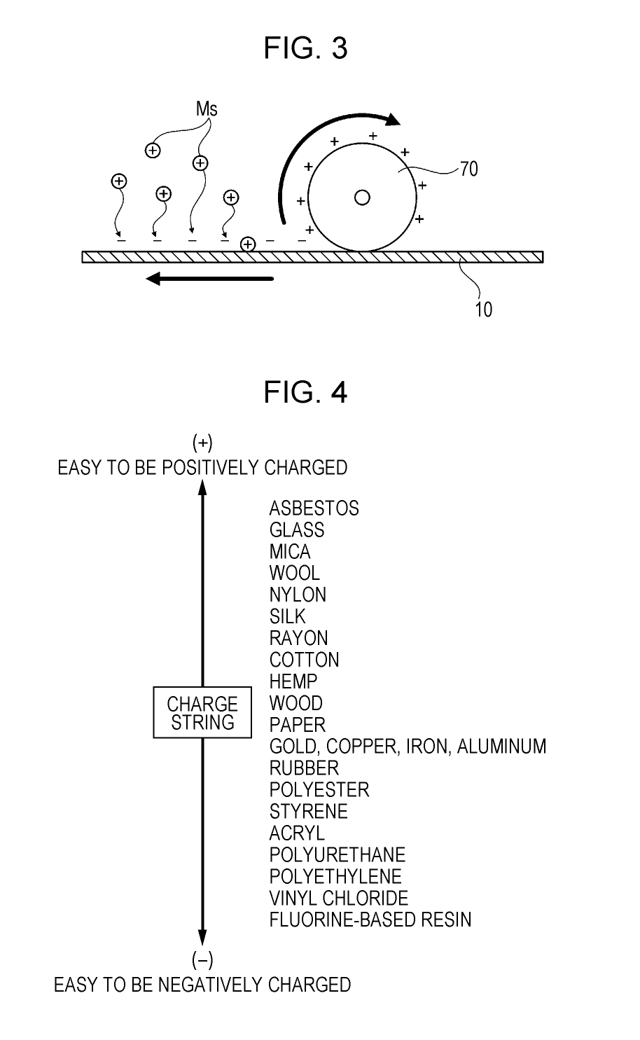

FIG. 3 is a schematic diagram illustrating a state in which floating mist Ms adheres to a surface of the recording medium 10 and thereby a surface of the recording medium 10 is contaminated. In the present figure, the roller 70 is different from a roller that configures a transport path in the present embodiment, and is described as a general roller.

As illustrated in FIG. 3, there is a case in which the roller 70 that peels off from a surface of the recording medium 10 by being in contact with the surface (recording surface) of the recording medium 10 and rotating performs peel-off charging with respect to the recording medium 10. In a case in which a material of the outer circumference portion of the roller 70 is located on a positive side of a material of the surface of the recording medium 10 on a charge string, if the surface of the recording medium 10 is peeled from the outer circumference portion of the contacted roller 70, there is a tendency that a surface of the outer circumference portion of the contacted roller 70 is positively charged and the surface of the recording medium 10 is negatively charged. In contrast to this, in a case in which the floating mist Ms is positively charged, the mist Ms adheres to the surface of the recording medium 10 that is negatively charged. This adhesion is concentrated in an area at which the roller 70 is in contact with the surface of the recording medium 10, and a desired image to be formed is contaminated.

FIG. 4 illustrates a portion of a charge string.

In a case in which a material of the outer circumference portion of the roller 70 is located on a positive side of a material of the surface of the recording medium 10 on the charge string, specifically, for example, in a recording device that performs recording on the recording medium 10, in a surface of which polyethylene, vinyl chloride, or the like is utilized, there is a case in which the outer circumference portion of the roller 70 that is in contact with the surface of the recording medium 10 and rotates is configured by a material, such as, iron, aluminum, rubber, polyurethane, or the like.

In addition, as in a case in which the floating mist Ms is positively charged, a case in which ink droplets are positively charged in a step in which the ink droplets are ejected from a nozzle, and the divided mist Ms is also positively charged and floats as it is, a case in which, in a step in which ink droplets are ejected from a nozzle, the ink droplets are divided into the main liquid droplets Md that are negatively charged and the mist Ms that is positively charged, and the mist Ms that is positively charged floats, a case in which the mist Ms that is gradually and positively charged after the division floats, or the like is considered.

Hereinafter, factors of a case in which the floating mist Ms is positively charged will be specifically described.

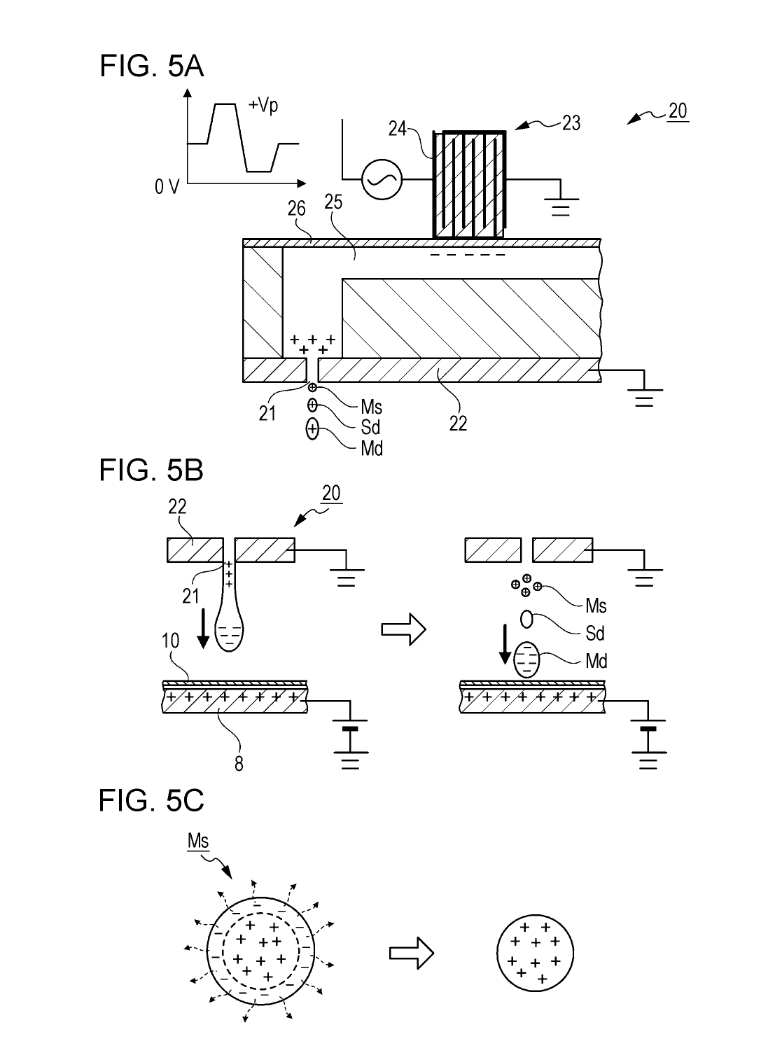

FIG. 5A to FIG. 5C are schematic diagrams illustrating a state in which the mist Ms is positively charged.

FIG. 5A illustrates a case in which ink droplets are positively charged, in a step in which the ink droplets are ejected from the nozzle 21. A case in which a drive voltage +Vp that is a positive potential with respect to ink is applied to a drive electrode 24 of a piezoelectric element 23 included in the recording head 20, or the like corresponds to the case.

By applying the drive voltage +Vp to the drive electrode 24, a pressure change is generated in the ink in a pressure chamber 25, and it is possible to eject the ink droplets into the recording medium 10 from the nozzle 21 using the pressure change.

In the configuration, when a positive voltage is input to the drive electrode 24 of the piezoelectric element 23, negative electric charges are induced by electrostatic induction in the vicinity of the piezoelectric element 23 over the ink in the pressure chamber 25, because the piezoelectric element 23 and the pressure chamber 25 are insulated to each other by a partition wall 26. In addition, positive electric charges are induced to the ink in the vicinity of the nozzle 21 which are located on a side opposite to the piezoelectric element 23. As illustrated in FIG. 5A, in a case in which a nozzle plate 22 is grounded, the positive electric charges that is induced move to the nozzle plate 22, but in a case of a configuration in which ink is ejected at a higher drive frequency, the ink is ejected from the nozzle 21, in a state in which the positive electric charges slightly remain. As a result, ink droplets (main liquid droplets Md, satellite droplets Sd, mist Ms) that are ejected from the nozzle 21 are positively charged.

FIG. 5B illustrates a case in which ink droplets are divided into main liquid droplets Md that are negatively charged and the mist Ms that is positively charged in a step in which the ink droplets are ejected from the nozzle 21. A case in which the nozzle plate 22 is grounded and a positive potential is provided to the platen 8, or the like corresponds to the case.

As illustrated in the left figure of FIG. 5B, in a process in which the ink that is ejected from the nozzle 21 of the recording head 20 extends toward the recording medium 10 and the platen 8, while negative electric charges are induced to a head portion (portion which becomes the main liquid droplets Md) on a side close to the platen 8 by electrostatic induction from the platen 8 with a positive potential, positive electric charges are induced to a trail portion on a side close to the nozzle 21 opposite to the head portion. Next, as illustrated in the right figure of FIG. 5B, in a case in which ink that is ejected from the nozzle 21 is divided into the main liquid droplets Md, the satellite droplets Sd, and the mist Ms, the main liquid droplets Md are negatively charged, the mist Ms is positively charged.

FIG. 5C illustrates a case in which the mist Ms is gradually and positively charged. A case in which ink is water soluble and air that is in contact with the mist Ms is positively charged, or the like corresponds to the case.

As illustrated in the left figure of FIG. 5C, moisture on a surface side of the mist Ms evaporates with negative electric charges, and thereby most of the positive electric charges remain and float as the mist Ms that is positively charged, as illustrated in the right figure of FIG. 5C.

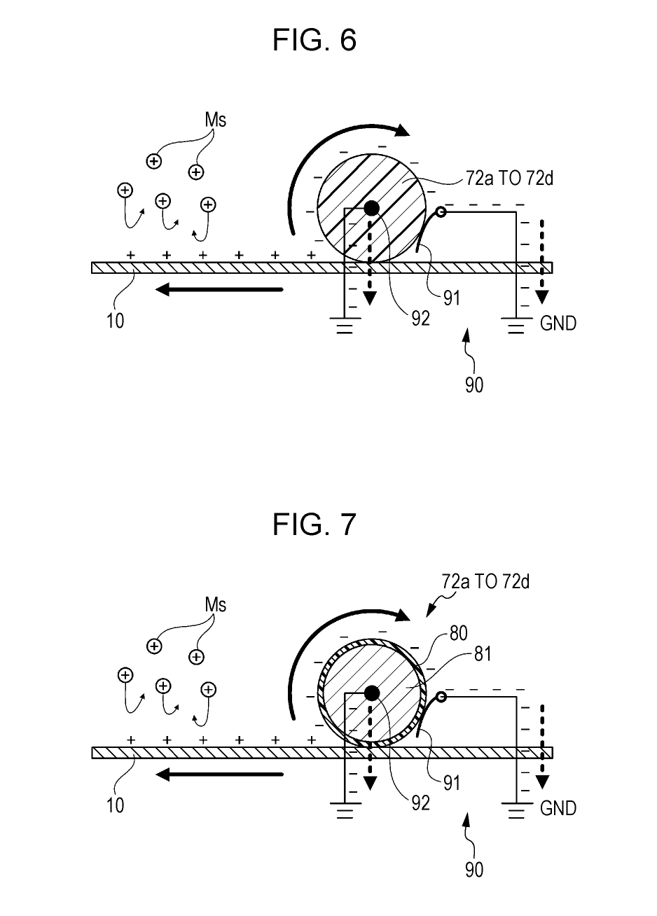

FIG. 6 is a schematic diagram illustrating a configuration of one of the slave rollers 72a to 72d that are used as “contact members” in the present embodiment.

The present embodiment is a recording device in which the mist Ms that is generated due to ejection of ink droplets by any one of the factors described above or other factors is positively charged. In correspondence to this, in the present embodiment, a fluorine-based resin is used for a base material of the slave rollers 72a to 72d. In addition, a base material of a fluorine-based resin contains carbon black that is used as a conductive material and is uniformly kneaded.

For example, polytetrafluoroethylene (PTEF) can be used for the fluorine-based resin. The fluorine-based resin is not limited to the PTEF, and may use, for example, a tetrafluoroethylene-perfluoroalkyol vinyl ether copolymer (PFA), a tetrafluoroethylene-hexafluoropropylene copolymer (FEP), a tetrafluoroethylene-ethylene copolymer (ETFE), polyvinylidene fluoride (PVDF), polychlorotrifluoroethylene (PCTFE), a chlorotrifluoroethylene-ethylene copolymer (ECTFE), or the like.

In addition, the slave rollers 72a to 72d have a static elimination path 90 in which electric charges that are charged on a contact surface in which the slave rollers 72a to 72d are in contact with the recording medium 10 move away from the contact surface.

For example, as illustrated in FIG. 6, specifically, the static elimination path 90 is configured by a static elimination brush 91 that is in contact with the contact surface, and the static elimination brush 91 is coupled to a ground potential (GND).

The static elimination path 90 is not limited to a configuration made by the static elimination brush 91, and may be configured in such a manner that a shaft portion 92 made by a metal which is supported so as to be able to rotate the slave rollers 72a to 72d having conductivity by using carbon black is coupled to the ground potential (GND), as illustrated in FIG. 6.

It is preferable that a content of carbon black is determined by an appropriate evaluation. Specifically, it is preferable that the conductivity is set in such a manner that a potential difference (potential difference between the slave rollers 72a to 72d and the ground potential) which is generated by peel-off charging of the recording medium 10 and the slave rollers 72a to 72d is equal to or lower than 500 V.

As described above, according to the recording device of the present embodiment, it is possible to obtain the following effects.

The materials of the slave rollers 72a to 72d that are in contact with a recording surface of the recording medium 10 are fluorine-based resins. For example, in a charge string, a metal such as gold, silver, copper, or aluminum, or rubber is located on a positive side of a material such as polyester, styrene, acryl, polyurethane, polyethylene, or vinyl chloride, and in contrast to this, the fluorine-based resin is located on a negative side of the material. For this reason, there is a tendency that, in peel-off charging of the recording medium 10 and the slave rollers 72a to 72d for which a material such as polyester, styrene, acryl, polyurethane, polyethylene, or vinyl chloride is used in the surface, the slave rollers 72a to 72d are negatively charged, and a recording surface of the recording medium 10 is positively charged. As a result, as illustrated in FIG. 6, adhesion of the mist Ms to the recording surface is suppressed by a repulsive force that acts between the recording surface and the mist Ms.

That is, according to the present embodiment, even in a case in which a material such as polyester, styrene, acryl, polyurethane, polyethylene, or vinyl chloride is used for the surface of the recording medium 10, adhesion of the mist Ms to the recording surface is suppressed, in a case in which the mist Ms that is generated when the recording head 20 ejects ink droplets onto the recording medium 10 is positively charged.

In addition, since the slave rollers 72a to 72d have the static elimination path 90 in which electric charges that are charged on the contact surface in which the slave rollers 72a to 72d are in contact with the recording medium 10 move away from the contact surface, the negative electric charges that are charged and stored on the contact surface via the static elimination path 90 can be reduced. As a result, an increase of a potential difference between the contact surface and other sites (for example, the ground potential) is suppressed, and adhesion of the mist Ms that is positively charged to the contact surface of the slave rollers 72a to 72d that are negatively charged is suppressed. In addition, discharging that is generated as a result in which a potential difference between the contact surface of the slave rollers 72a to 72d and other sites (for example, the ground potential) is increased is suppressed. In a case in which the discharging is performed across the recording medium 10, the recording surface of the recording medium 10 is negatively charged by the discharging, and the mist Ms that is positively charged can adhere to the recording surface that is negatively charged. Since generation of the discharging is suppressed, contamination of the recording surface due to adhesion of the mist Ms is suppressed.

In addition, since the slave rollers 72a to 72d contain carbon black as a conductive material, the static elimination path 90 that is electrically coupled to the slave rollers 72a to 72d is provided, and thus, it is possible to more easily move electric charges that are charged in the slave rollers 72a to 72d via the static elimination path 90.

In addition, the static elimination path 90 electrically couples the slave rollers 72a to 72d to the ground potential. For this reason, it is possible to move electric charges that are charged in the slave rollers 72a to 72d to the ground potential via the static elimination path 90.

In the above description, all the slave rollers 72a to 72d are configured by a fluorine-based resin, and the static elimination path 90 is provided for the slave rollers 72a to 72d, but it is not necessary for all the slave rollers 72a to 72d to be configured by such a configuration. For example, in a case in which the slave rollers 72c and 72d are located in areas that are not affected by the floating mist Ms (that is, in a case in which there is no possibility of contamination due to adhesion of the mist Ms, even if the recording surface of the recording medium 10 is charged by peel-off charging of the slave rollers 72c and 72d and the recording medium 10), it is not necessary for the slave rollers 72c and 72d to be configured in such a manner.

In addition, in the present embodiment, an example is described in which, in correspondence to a case in which the mist Ms that is generated according to the ejection of ink droplets is positively charged, the fluorine-based resin is used for a base material of the slave rollers 72a to 72d, but the invention is not limited to this. For example, in a case in which the mist Ms is negatively charged, a material of the contact surface of the slave rollers 72a to 72d may be a material which is located in a positive side further than a material of a member that configures the recording surface of the recording medium 10. Adhesion of the mist Ms to the recording surface is suppressed by the repulsive force that acts between the recording surface which is negatively charged and the mist Ms which is negatively charged. That is, the material of the contact surface of the slave rollers 72a to 72d that are in contact with the recording surface of the recording medium 10 in a transport path through which the recording medium 10 is transported may be a material that is located on a polarity side opposite to a polarity in which the mist Ms in a charge string is charged, further than a material of a member that configures the recording surface of the recording medium 10.

In addition, in the present embodiment, an example is described in which the slave rollers 72a to 72d are respectively used as a “contact member”, but the contact member is not limited to the slave rollers 72a to 72d. For example, it is preferable that, in a case in which a pressing plate or the like that presses a portion of the recording surface so as to flatly support the recording medium 10 on the platen 8 is provided, the pressing plate is also configured in the same manner as the contact member according to the present embodiment.

The invention is not limited to the embodiments described above, and various modifications, changes or the like can be applied to the embodiments described above. A modification example will be described hereinafter. Here, the same symbols or reference numerals will be used for the same configuration sites as those of the embodiments described above, and repeated description will be omitted.

### First Modification

FIG. 7 is a schematic diagram illustrating a configuration of a slave roller according to a first modification example.

In the first embodiment, as illustrated in FIG. 6, a description is made in which the fluorine-based resin is used for the base material of the slave rollers 72a to 72d, but the invention is not limited to this configuration, and a configuration may be made in which the fluorine-based resin is used for only outer circumference areas 80 of the slave rollers 72a to 72d that are in contact with the recording surface of the recording medium 10. In addition, in the same manner as in a case of the first embodiment, carbon black that is used as a conductive material and is uniformly kneaded is contained in the fluorine-based resin of the outer circumference area 80.

An internal area 81 that supports the outer circumference area 80 is configured by a metal such as stainless used steel (SUS).

According to the recording device of the present embodiment, the following effect can be obtained, in addition to the effects of the embodiments described above.

The outer circumference areas 80 of the slave rollers 72a to 72d can be configured by a tube in which, for example, a fluorine-based resin is used, and is configured in such a manner that attachment and detachment or the like in accordance with a material of the recording surface of the recording medium 10 is conveniently performed.

In addition, the internal area 81 that supports the outer circumference area 80 is configured by a metal, and thereby it is possible to further reduce an electrical resistance of the static elimination path, for example, in a case in which the static elimination path 90 is configured so as to be coupled to the ground potential from the shaft portion 92 made by a metal that supports the slave rollers 72a to 72d in a rotatable manner.

The entire disclosure of Japanese Patent Application No.2014-132275, filed Jun. 27, 2014 is expressly incorporated by reference herein.

What is claimed is:

1. A recording device which ejects ink droplets onto a recording surface of a recording medium thereby recording, comprising:
a material of a contact member that is in contact with the recording surface in a transport path through which the recording medium is transported, the material being located on a polarity side opposite to a polarity in which mist that is generated in accordance with ejection of the ink droplets in a charge string is charged, further than a material of a member which configures the recording surface.

2. A recording device which ejects ink droplets onto a recording surface of the recording medium thereby recording, comprising:
a material of a contact member that is in contact with the recording surface in a transport path through which the recording medium is transported, the material being located on a negative side in a charge string, further than a material of a member which configures the recording surface.

3. The recording device according to claim 1, further comprising:
a static elimination path through which electric charges that are charged in a contact surface on which the contact member is in contact with the recording medium move away from the contact surface.

4. The recording device according to claim 1, further comprising:
a transport portion that transports the recording medium,
wherein the contact member is a roller that configures the transport portion.

5. The recording device according to claim 1, wherein the contact member contains a conductive material.

6. The recording device according to claim 3, wherein the static elimination path electrically couples the contact member to a ground potential.

7. The recording device according to claim 2, wherein a material of the contact member is a fluorine-based resin.
